(19) United States
(12) Patent Application Publication
(10) Pub. No.: US 2026/0037885 A1
(43) Pub. Date: Feb. 5, 2026

(54) INTELLIGENT METHOD AND APPARATUS TO AUGMENT MODERATOR IN LIVE SESSION LEVERAGING GENERATIVE ARTIFICIAL INTELLIGENCE

(71) Applicant: Bank of America Corporation, Charlotte, NC (US)

(72) Inventors: Juna Mukherjee, Hyderabad (IN); Shailendra Singh, Maharashtra (IN)

(21) Appl. No.: 18/792,801

(22) Filed: Aug. 2, 2024

(51) Int. Cl. G06Q 10/0631

(52) U.S. Cl. CPC G06Q 10/0631

(57) ABSTRACT

A method for dynamically augmenting a live session leveraging a generative AI engine is provided. The method may include receiving information relating to topics for discussion during the live session, an amount of time for conducting the live session and users to present the topics. The method may include generating, by the generative AI engine, an agenda for the live session based on the received information. The method may include selecting a sensitivity level for the live session. The method may include selecting sources to link to the agenda. Methods may include executing the live session by the generative AI engine. Methods may include monitoring the live session. Methods may include deploying a corrective action based on a detection of a deviation from the agenda.

### FIELD OF TECHNOLOGY

Aspects of the disclosure relate to augmenting capabilities of a moderator leveraging generative artificial intelligence (“AI”) technology.

### BACKGROUND OF THE DISCLOSURE

Entities are increasingly conducting live sessions with members of their team. The live sessions may be educational, instructive, informative and/or collaborative in design. The entities may conduct the live sessions with certain goals in mind. The goals may include conveying certain information. The entities may conduct the live sessions using video conferencing applications, slideshows, microphones/speakers and/or any other suitable conferencing technologies.

In order for the live sessions to be efficient and effective, large amounts of time and energy are required to prepare for the live sessions. In order to convey the correct information in a manner the audience can digest, a moderator of the live session needs to generate a content creation plan before the live session. The moderator may need to rigorously research and plan for the content creation plan. The content creation plan may require multiple speakers or panelists.

The speakers and panelists may need to prepare for the session. The speakers and panelists may need to prepare for impromptu questions from the audience. The speakers and panelist may not know the answers to the impromptu questions. The speakers and panelist may need to condense their speaking times to adjust for other speakers. A speaker or panelist may unexpectedly cancel their role right before the live session.

Audience participation may direct the live session away from the goal. Audience participation or unpredictable speakers/panelists may cause other issues during the live session such as purposefully deviating from the established live session plan or introducing prohibited topics of discussion.

It would be desirable to provide a generative AI engine to create content for a live session. It would be further desirable to provide a generative AI engine to create an agenda and sequence map for a live session. It would be further desirable to provide a generative AI method for executing and monitoring a live session.

### SUMMARY OF THE DISCLOSURE

A method for dynamically augmenting a live session leveraging a generative AI engine. The method may include receiving information. The information may relate to a plurality of topics for discussion during the live session, an aggregate amount of time for conducting the live session and one or more users to present the plurality of topics. The method may include generating an agenda for the live sessions, based on the received information. The generating may include selecting from the plurality of topics one or more topics to present, assigning respective users from the one or more users to present the one or more topics to present, assigning a respective amount of time for each selected topic to present and assigning a respective amount of time for each of the one or more users to present the respective topic to present. The method may include selecting a sensitivity level for the live session. The method may include selecting one or more of a plurality of sources to link to the agenda. The method may include executing the live session by the generative AI engine. Executing the live session may include generating talking points for each topic of the selected topics. Executing the live session may include deploying each talking point to a plurality of use devices, each user device associated with at least one of the one or more users, respective talking points being deployed to the user device associated with the one or more users presenting the corresponding selected one or more topics. Executing the live session may include, upon deployment of the respective talking points, prompting the respective one or more users to accept, decline or revise the talking points. Executing the live session may include monitoring the live session. Monitoring the live session may include actively processing conversation of participants of the live session. Monitoring the live session may include actively keeping track of the respective amount of time utilized during the live session for each of the selected one or more topics. Monitoring the live session may include actively keeping track of the amount of time each of the one or more users is presenting. The method may include, in response to a deviation from the agenda, deploying a corrective action to each device. The deviation may include a deviation from the respective amount of time for each selected topic to present or the respective amount of time for each of the one or more users to present the respective topic to present. The plurality of sources may include websites, private servers and databases. The corrective action may include additional talking points, adjustment of the one or more topics to present, adjustment of the respective amount of time for each selected topic to present, adjustment of the respective amount of time for one or more users to present the respective topic and adjustment of the one or more users to present each topic. Processing the conversation may include passing the conversation through a speech spectrogram to generate a speech evaluation record. The generative AI engine may extract a text context from the speech evaluation record via a speech-text extraction engine. The generative AI engine may extract a voice analysis from the speech evaluation record via a speech-voice analysis engine.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows a diagram in accordance with principles of the disclosure;

FIG. 4 shows a flow diagram in accordance with principles of the disclosure; and

FIG. 5 shows a flow diagram in accordance with principles of the disclosure.

### DETAILED DESCRIPTION OF THE DISCLOSURE

A technology according to the disclosure can significantly increase ease of managing live sessions. Such a technology could significantly improve productivity and efficiency for moderators of live sessions.

Provided may be apparatus and methods for dynamically augmenting a live session leveraging a generative artificial intelligence (“AI”) engine. Live sessions may be planned out ahead of time. A moderator may be in charge of planning out the live sessions. The moderator may utilize the generative AI engine to assist in planning and carrying out the live session. The moderator may execute a live session seamlessly by generating autogenerated prompts using the generative AI engine. The live sessions may include the moderator. The live sessions may include a plurality of panelists. The live sessions may include a plurality of users. The live sessions may include an audience. The live sessions may be conducted virtually. The live sessions may be conducted in person. The live sessions may include prerecorded material. The live sessions may be recorded. The live sessions may be planned ahead of time. The live sessions may include an agenda. The live sessions may include a sequence map. The users, panelists, audience and moderator may log into the live session via personal devices.

The apparatus and methods may include the generative AI engine receiving information before conducting the live session. The information may include a plurality of topics for discussion during the live session. The topics may include educational, business, informational, collaborative or any other suitable topics for discussion during the live sessions. The information may include an aggregate amount of time allotted to the live session. The information may include one or more users to present the plurality of topics. The information may include an objective for the live session. The generative AI engine may receive the information from the moderator. The generative AI engine may receive the information from a user. The generative AI engine may receive the information from a panelist. The generative AI engine may receive the information from a database.

The database may be stored on a server. The server may schedule the live sessions. The server may schedule the live sessions automatically. The server may schedule the live sessions at regular intervals. The server may schedule the live sessions when the database has gathered enough relevant information relating to a topic for discussion during a live session.

The generative AI engine may generate an agenda for a live session based on the received information. Generating the agenda may include selecting from the plurality of topics one or more topics to present. The generative AI engine may select the topics by determining which topics are most relevant to the live session's objective. The generative AI engine may select the topics based on time constraints.

Generating the agenda may include assigning users to present the selected topics. One user may be assigned for each topic. Multiple users may be assigned for each topic. One user may be assigned for multiple topics. The generative AI engine may select specific users to present specific topics based on their credentials. The generative AI engine may select the users based on their knowledge of the topic. The generative AI engine may select the users based on which user is available.

Generating the agenda may include assigning amounts of time for each selected topic to present. The generative AI engine may select the amount of time for each topic based on the aggregate amount of time for the live session. The generative AI engine may select the respective amounts of time based on the relevance of the topic to the objective. The generative AI engine may select the respective amounts of time based on the presenter of the respective topic.

Generating the agenda may include assigning a respective amount of time for each user to present their topic or portion of the topic.

The agenda may include a list of topics. The agenda may include the time assigned for each topic to present. The agenda may include the users/panelists assigned to present the respective topics. The agenda may include the time and date of the live session. The agenda may include a location of the live session. The agenda may include a sequence map of the live session.

The generative AI engine may select a sensitivity level for the live session. The sensitivity level may be selected based on the objective. The sensitivity level may be selected based on the audience. The sensitivity level may be selected based on the users/panelists. The generative AI engine may detect users, panelists and audience members as they log into the live session. The generative AI engine may include a database of the users, panelists and audience members. The generative AI engine may adjust the sensitivity level based on the detected users. The sensitivity level may relate to content that is appropriate for the detected users of the live session.

The generative AI engine may select one or more sources to link to the agenda. The sources may include websites, private servers, databases or any other suitable source of data. The generative AI engine may select the sources based on whether the content accessible on the sources matches the topics. The generative AI engine may select the sources based on availability of the source.

The generative AI engine may execute the live session. The execution of the live session may include preparation for the live session. The preparation may occur before the live session is conducted. The preparation may include generating talking points for each topic of the selected topics. The generative AI engine may generate the talking points based on the received information. The generative AI engine may generate the talking points based on the objectives. The generative AI engine may generate the talking points from data received from the sources. The moderator may send talking points to the generative AI engine. The generative AI engine may use the sent talking points as a starting point when generating the talking points. The talking points may include a script. The talking points may include an audio component.

The talking points may be sent to the moderator before conducting the live session. The moderator may approve the talking points. The moderator may decline the talking points. The moderator may revise the talking points.

The execution of the live session may include deploying the talking points to user devices. The generative AI engine may deploy the talking points before conducting the live session. The generative AI engine may deploy the talking points during the live session. Users may log into the live session. The generative AI engine may register the user devices that are logged into the live session. The generative AI engine may deploy the talking points to all registered user devices. The generative AI engine may deploy the respective talking points to the respective user/panelists assigned to present the talking points. The generative AI engine may deploy the talking points to one device that is shared among the users/panelists. The user/panelist may be prompted to accept the talking points before conducting the live session. The user/panelist may be prompted to accept the talking points during the live session. The user devices may include a computer, smartphone, tablet, laptop, headset, earbuds, speaker or any other suitable device. The user device may act as an intelligent or smart teleprompter. The teleprompter may dynamically show the user the talking points and update the talking points in real time based on the conversation.

The content of the talking points may be generated based on the sensitivity level. The content of the talking points may be set to preclude talking points related to politics, religion, confidential information or any other subject matter deemed inappropriate due to the sensitivity level. The sensitivity level may be the highest sensitivity level of all registered users logged into the live session.

The execution of the live session may include monitoring the live session. Monitoring the live session may include actively processing conversation of the live session. The a speech spectrogram may be present during the live session. The speech spectrogram may record the conversation. The speech spectrogram may dynamically generate a speech evaluation record.

The generative AI engine may include a speech-voice analysis engine. The speech-voice analysis engine may extract a voice analysis from the speech evaluation record. The voice analysis may include a tone of the speaker, a cadence of the speaker and any other information relating to the voice of the speaker.

The generative AI engine may include a speech-text extraction engine. The speech-text extraction engine may extract a text context from the speech evaluation record. The text context may include words spoken during the conversation. The generative AI engine may distinguish between users based on the voice analysis and the text context. The generative AI engine may determine what each user contributed to the conversation based on the voice analysis and the text context. The generative AI engine may determine the direction of the conversation based on the voice analysis and the text context.

The generative AI engine may dynamically process the conversation via the voice analysis and the text context. The generative AI engine may extract contextual text segments from the voice analysis and the text context. The contextual text segment may trigger a webhook event. The webhook event may cause the generative AI engine to analyze the contextual text segment and generate additional talking points. The additional talking points may include questions, answers, summary, statistics, text or any other suitable response to the contextual text segment.

Monitoring the live session may include keeping track of the amount of time utilized during the live session for each topic. The generative AI engine may determine the amount of time utilized for each topic by dynamically analyzing in real-time the text context. Based on the text context, the generative AI engine may determine which topic is being discussed in the conversation. The generative AI engine may log the amount of time in which the topic is being discussed.

Monitoring the live session may include keeping track of the amount of time each user is presenting. The generative AI engine may determine the amount of time each user is presenting by dynamically analyzing in real-time the voice analysis. Based on the voice analysis, the generative AI engine may determine which user is speaking in the conversation. The generative AI engine may log the amount of time in which the user is speaking.

The generative AI engine may deploy a corrective action to the user devices in response to a deviation from the agenda. The deviation may include a question received from the audience. The deviation may include going over the amount of time allotted for one of the topics. The deviation may include going over the amount of time allotted for a respective user. The amount of time that is considered a deviation may include 1, 2, 5, 10 or any suitable percentage over the time allotted.

The corrective action may include additional talking points. The corrective action may include removing talking points. The corrective action may include adjusting the topics to present. The corrective action may include adjusting the amount of time for each topic to present. The corrective action may include adjusting the amount of time of the users to present their respective topics. The corrective action may include adjusting which users present each topic.

The generative AI engine may generate the additional talking points dynamically in real-time. The generative AI engine may generate the additional talking points using data from the plurality of sources. The generative AI engine may generate the additional talking points based on the text context and the voice analysis of the conversation. The user receiving the deployed additional talking points may accept, decline or revise the deployed additional talking points.

The generative AI engine may alert the moderator when a deviation is detected. The generative AI engine may alert the user presenting at the time the deviation is detected. The generative AI engine may alert the moderator before deploying the corrective action. The moderator may be prompted to accept, decline or revise the corrective action before it is deployed. The user may be prompted to accept, decline or revise the corrective action after deployment. Upon the user declining the corrective action, the moderator may be alerted. The moderator may override the user. The moderator may instruct the generative AI engine to deploy the corrective action even upon the user declining the corrective action. The moderator may block the user from further participation in the live session. The moderator may block any user from further participation in the live session.

The generative AI engine may detect a question via monitoring the conversation. The generative AI engine may detect the question via the voice analysis and text context. The generative AI engine may generate dynamically in real-time an answer to the question. The generative AI engine may deploy the corrective action/additional talking points to the user presenting at the time of detection of the question. The generative AI engine may generate the answer using data from the plurality of linked sources.

The following figures and associated written specifications set forth the invention in additional detail to the foregoing.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

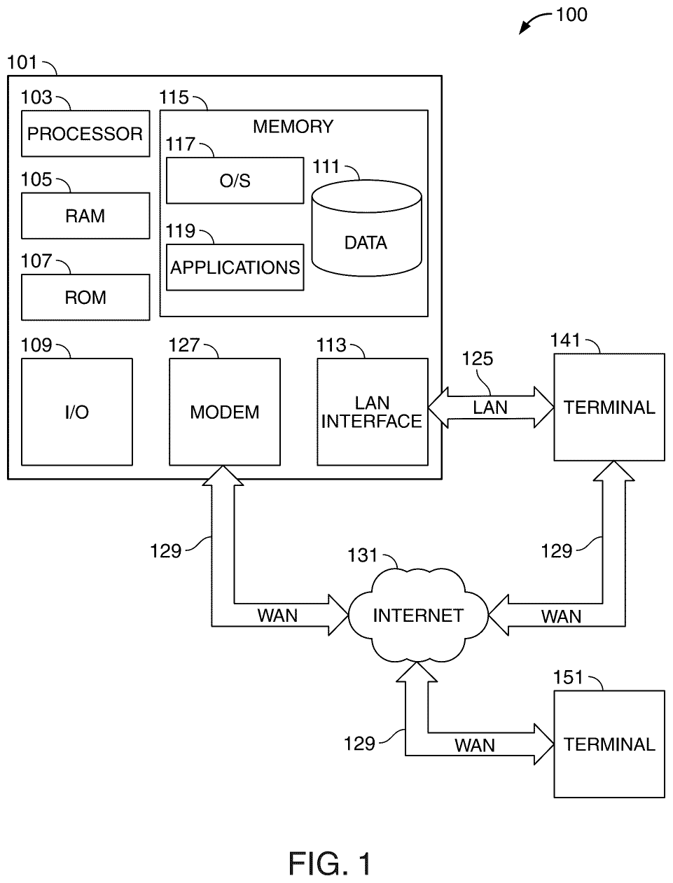

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

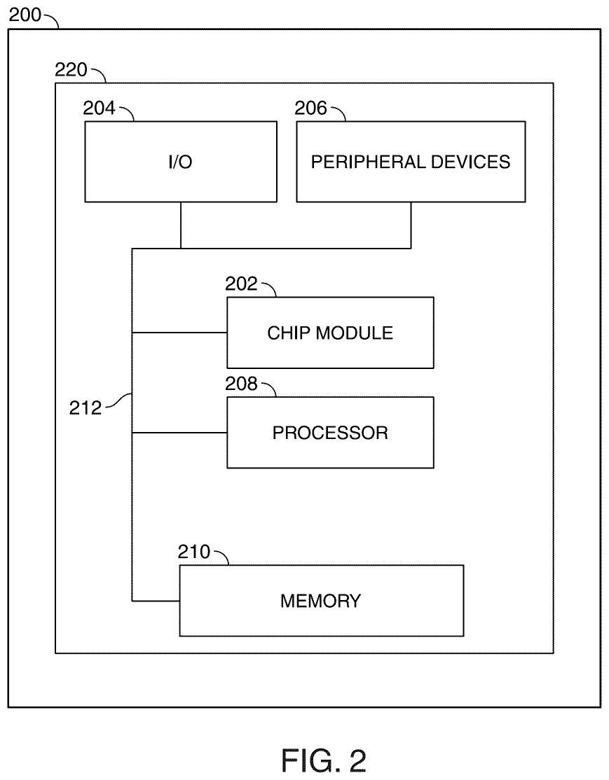

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

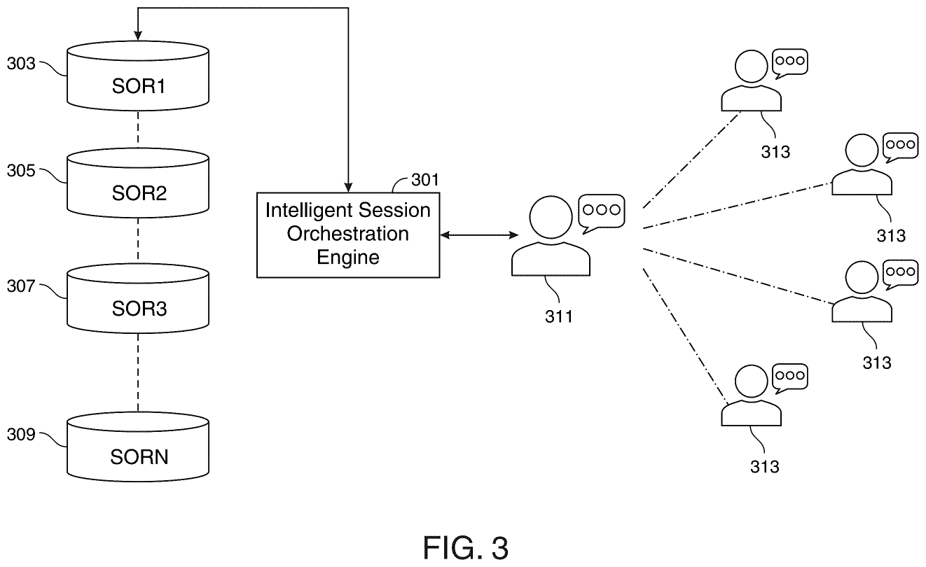

FIG. 3 shows a diagram in accordance with principles of the disclosure. Intelligent session orchestration engine 301 may communicate with sources 303, 305, 307 and 309. Sources 303, 305, 307 and 309 may be systems of records (“SOR”). Intelligent session orchestration engine 301 may communicate with moderator 311 of a live session. Moderator 311 may communicate with participants 313 of the live session.

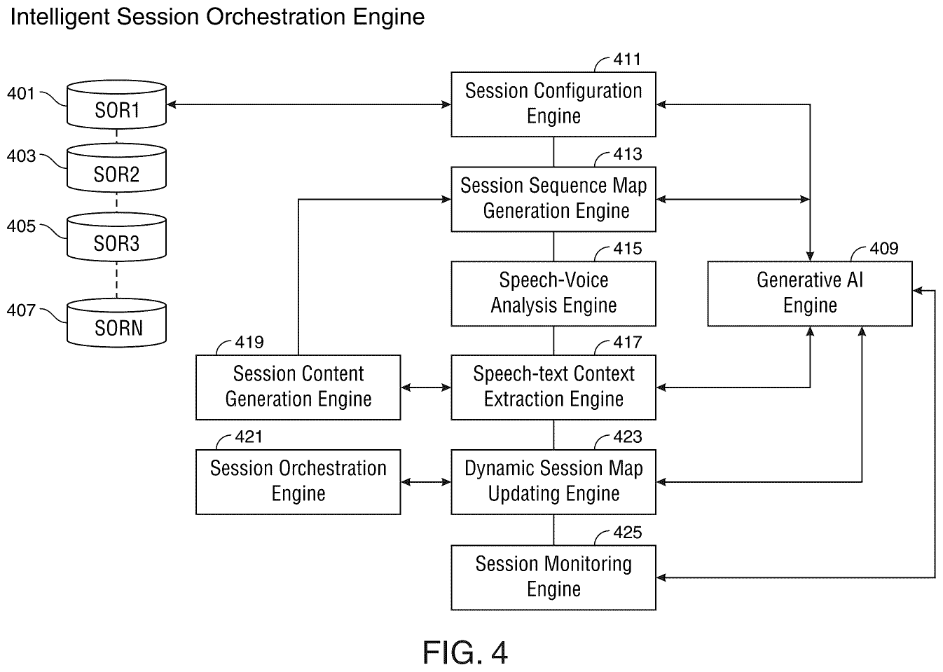

FIG. 4 shows a flow diagram in accordance with principles of the disclosure. Intelligent session orchestration engine 301 may include generative AI engine 409. Intelligent session orchestration engine 301 may include session configuration engine 411. Generative AI engine 409 may communicate with session configuration engine 411. Session configuration engine 411 may configure the logistics and settings for the session. Intelligent session orchestration engine 301 may include session sequence map generation engine 413. Generative AI engine 409 may communicate with session sequence map generation engine 413. Session sequence map generation engine 413 may generate the sequence map of the live session.

Intelligent session orchestration engine 301 may include speech-voice analysis engine 415. Speech-voice analysis engine 415 may communicate with generative AI engine 409. Speech-voice analysis engine 415 may receive data from a speech spectrogram. Speech-voice analysis engine 415 may extract a voice analysis from the speech spectrogram.

Intelligent session orchestration engine 301 may include speech-text context extraction engine 417. Speech-text context extraction engine 417 may communicate with generative AI engine 409. Speech-text context extraction engine 417 may receive data from the speech spectrogram. Speech-text context extraction engine 417 may extract a text context from the speech spectrogram.

Intelligent session orchestration engine 301 may include session content generation engine 419. Session content generation engine 419 may communicate with speech-text context extraction engine 417. Session content generation engine 419 may communicate with generative AI engine 409. Session content generation engine 419 may dynamically generate the content for the live session. The content may include talking points.

Intelligent session orchestration engine 301 may include session orchestration engine 421. Session orchestration engine 421 may execute the live session.

Intelligent session orchestration engine 301 may include dynamic session map updating engine 423. Dynamic session map updating engine 423 may update the sequence map during the live session automatically.

Intelligent session orchestration engine 301 may include session monitoring engine 425. Session monitoring engine 425 may monitor the session via the speech spectrogram and/or time feeds.

Intelligent session orchestration engine 301 may communicate with sources 401, 403, 405 and 407.

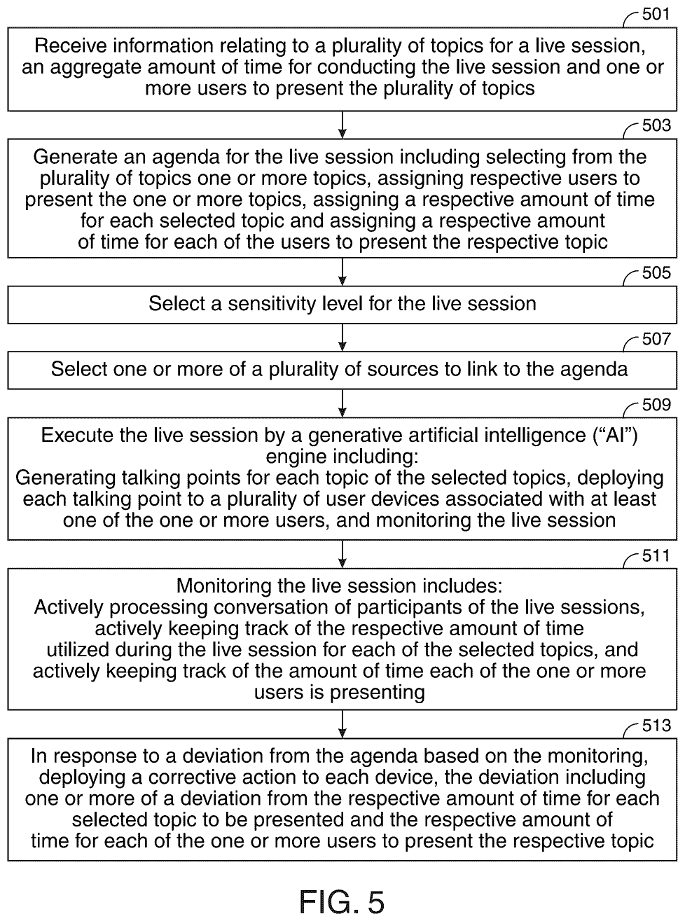

FIG. 5 shows a flow diagram in accordance with principles of the disclosure. At step 501 methods may include receiving information relating to a plurality of topics for a live session, an aggregate amount of time for conducting the live session and one or more users to present the plurality of topics. At step 503 methods may include generating an agenda for the live session including selecting from the plurality of topics one or more topics, assigning respective users to present the one or more topics, assigning a respective amount of time for each selected topic and assigning a respective amount of time for each of the users to present the respective topic.

At step 505 methods may include selecting a sensitivity level for the live session. At step 507 methods may include selecting one or more of a plurality of sources to link to the agenda. At step 509 methods may include executing the live session by a generative artificial intelligence (“AI”) engine including generating talking points for each topic of the selected topics, deploying each talking point to a plurality of user devices associated with at least one of the one or more users and monitoring the live session.

At step 511 methods may include monitoring the live session includes actively processing conversation of participants of the live sessions, actively keeping track of the respective amount of time utilized during the live session for each of the selected topics and actively keeping track of the amount of time each of the one or more users is presenting.

At step 513 methods may include in response to a deviation from the agenda based on the monitoring, deploying a corrective action to each device, the deviation including one or more of a deviation from the respective amount of time for each selected topic to present and the respective amount of time for each of the one or more users to present the respective topic.

Thus, methods and apparatus for providing an intelligent method and apparatus to augment moderator in live session leveraging generative artificial intelligence are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for dynamically augmenting a live session leveraging a generative artificial intelligence (“AI”) engine, the method comprising:
receiving information relating to:
a plurality of topics for discussion during the live session;
an aggregate amount of time for conducting the live session; and
one or more users to present the plurality of topics;
generating an agenda for the live session, based on the received information, the generating comprising:
selecting from the plurality of topics one or more topics to present;
assigning respective users from the one or more users to present the one or more topics to present;
assigning a respective amount of time for each selected topic to present; and
assigning a respective amount of time for each of the one or more users to present the respective topic to present;
selecting a sensitivity level for the live session;
selecting one or more of a plurality of sources to link to the agenda;
executing the live session by the generative AI engine, the executing comprising:
generating talking points for each topic of the selected topics;
deploying each talking point to a plurality of user devices, each user device associated with at least one of the one or more users, respective talking points being deployed to the user device associated with the one or more users presenting the corresponding selected one or more topics;
upon deployment of the respective talking points, prompting the respective one or more users to accept, decline or revise the talking points; and
monitoring the live session, the monitoring comprising:
actively processing conversation of participants of the live session;
actively keeping track of the respective amount of time utilized during the live session for each of the selected one or more topics; and
actively keeping track of the amount of time each of the one or more users is presenting; and
in response to a deviation from the agenda, deploying a corrective action to each device, the deviation including one or more of a deviation from:
the respective amount of time for each selected topic to present; and
the respective amount of time for each of the one or more users to present the respective topic to present;
wherein:
the sources include websites, private servers and databases;
the corrective action includes one or more of additional talking points, adjustment of the one or more topics to present, adjustment of the respective amount of time for each selected topic to present, adjustment of the respective amount of time for one or more users to present the respective topic and adjustment of the one or more users to present each topic;
processing the conversation includes passing the conversation through a speech spectrogram to generate a speech evaluation record;
the generative AI engine extracts a text context from the speech evaluation record via a speech-text context extraction engine; and
the generative AI engine extracts a voice analysis from the speech evaluation record via a speech-voice analysis engine.

2. The method of claim 1 further comprising upon detection of a question from text context and voice analysis, the generative AI engine:
generates an answer to the question; and
deploys the answer to the user devices in real-time;
wherein the generative AI engine generates the answer from data from the plurality of sources.

3. The method of claim 1 wherein:
the generative AI engine deploys the corrective action based on the text context and the voice analysis; and
the generative AI engine generates the additional talking points based on the text context and the voice analysis.

4. The method of claim 3 wherein the generative AI engine dynamically generates the additional talking points using information from the selected sources.

5. The method of claim 1 further comprising:
selecting a moderator for the live session;
alerting the moderator when the deviation is detected, before deploying the corrective action; and
receiving instructions in real-time from the moderator, whether to deploy the corrective action upon receipt of the alert.

6. The method of claim 5 wherein the user associated with the user device on which the corrective action is deployed is prompted to accept or decline the corrective action.

7. The method of claim 6 wherein, upon the user declining the corrective action, the moderator is prompted to accept or decline blocking the user from further participation in the live session.

8. The method of claim 1 wherein the deployed talking points are adjusted based on the selected sensitivity level.

9. A system for dynamically augmenting a live session leveraging a generative artificial intelligence (“AI”) engine, the system comprising:
a processor;
a memory; and
a non-transitory computer readable medium storing instructions that when executed by the processor:
receives information relating to:
a plurality of topics for discussion during the live session;
an aggregate amount of time for conducting the live session; and
one or more users to present the plurality of topics;
generates an agenda for the live session, based on the received information, comprising:
selecting from the plurality of topics one or more topics to present;
assigning respective users from the one or more users to present the one or more topics to present;
assigning a respective amount of time for each selected topic to present; and
assigning a respective amount of time for each of the one or more users to present the respective topic to present;
selects a sensitivity level for the live session;
selects one or more of a plurality of sources to link to the agenda;
executes the live session by the generative AI engine comprising:
generating talking points for each topic of the selected topics;
deploying each talking point to a plurality of user devices, each user device associated with at least one of the one or more users, respective talking points being deployed to the user device associated with the one or more users presenting the corresponding selected one or more topics;
upon deployment of the respective talking points, prompting the respective one or more users to accept, decline or revise the talking points; and
monitoring the live session, the monitoring comprising:
actively processing conversation of participants of the live session;
actively keeping track of the respective amount of time utilized during the live session for each of the selected one or more topics; and
actively keeping track of the amount of time each of the one or more users is presenting; and
in response to a deviation from the agenda, deploys a corrective action to each device, the deviation including one or more of a deviation from:
the respective amount of time for each selected topic to present; and
the respective amount of time for each of the one or more users to present the respective topic to present;
wherein:
the sources include websites, private servers and databases;
the corrective action includes one or more of additional talking points, adjustment of the one or more topics to present, adjustment of the respective amount of time for each selected topic to present, adjustment of the respective amount of time for one or more users to present the respective topic and adjustment of the one or more users to present each topic;
processing the conversation includes passing the conversation through a speech spectrogram to generate a speech evaluation record;
the generative AI engine extracts a text context from the speech evaluation record via a speech-text context extraction engine; and
the generative AI engine extracts a voice analysis from the speech evaluation record via a speech-voice analysis engine.

10. The system of claim 9 wherein the instructions when executed by the processor further comprises upon detection of a question from text context and voice analysis, the generative AI engine:
generates an answer to the question; and
deploys the answer to the user devices in real-time;
wherein the generative AI engine generates the answer from data from the plurality of sources.

11. The system of claim 9 wherein:
the generative AI engine deploys the corrective action based on the text context and the voice analysis; and
the generative AI engine generates the additional talking points based on the text context and the voice analysis.

12. The system of claim 11 wherein the generative AI engine dynamically generates the additional talking points using information from the selected sources.

13. The system of claim 9 further comprising:
selecting a moderator for the live session;
alerting the moderator when the deviation is detected, before deploying the corrective action; and
receiving instructions in real-time from the moderator, whether to deploy the corrective action upon receipt of the alert.

14. The system of claim 13 wherein the user associated with the user device on which the corrective action is deployed is prompted to accept or decline the corrective action.

15. The system of claim 14 wherein, upon the user declining the corrective action, the moderator is prompted to accept or decline blocking the user from further participation in the live session.

16. The system of claim 9 wherein the deployed talking points are adjusted based on the selected sensitivity level.

17. A method for dynamically augmenting a live session leveraging a generative artificial intelligence (“AI”) engine, the method comprising:
receiving information relating to:
a plurality of topics for discussion during the live session;
an aggregate amount of time for conducting the live session; and
one or more users to present the plurality of topics;
generating an agenda for the live session, based on the received information, the generating comprising:
selecting from the plurality of topics one or more topics to present;
assigning respective users from the one or more users to present the one or more topics to present;
assigning a respective amount of time for each selected topic to present; and
assigning a respective amount of time for each of the one or more users to present the respective topic to present;
selecting a sensitivity level for the live session;
selecting one or more of a plurality of sources to link to the agenda;
executing the live session by the generative AI engine, the executing comprising:
generating talking points for each topic of the selected topics;
deploying each talking point to a plurality of user devices, each user device associated with at least one of the one or more users, respective talking points being deployed to the user device associated with the one or more users presenting the corresponding selected one or more topics;
upon deployment of the respective talking points, prompting the respective one or more users to accept, decline or revise the talking points; and
monitoring the live session, the monitoring comprising:
actively processing conversation of participants of the live session;
actively keeping track of the respective amount of time utilized during the live session for each of the selected one or more topics; and
actively keeping track of the amount of time each of the one or more users is presenting; and
in response to a deviation from the agenda, deploying a corrective action to each device, the deviation including one or more of a deviation from:
the respective amount of time for each selected topic to present; and
the respective amount of time for each of the one or more users to present the respective topic to present;
wherein:
the deployed talking points are adjusted based on the selected sensitivity level;
the sources include websites, private servers and databases;
the corrective action includes one or more of additional talking points, adjustment of the one or more topics to present, adjustment of the respective amount of time for each selected topic to present, adjustment of the respective amount of time for one or more users to present the respective topic and adjustment of the one or more users to present each topic;
processing the conversation includes passing the conversation through a speech spectrogram to generate a speech evaluation record;
the generative AI engine extracts a text context from the speech evaluation record via a speech-text context extraction engine;
the generative AI engine extracts a voice analysis from the speech evaluation record via a speech-voice analysis engine;
the generative AI engine deploys the corrective action based on the text context and the voice analysis; and
the generative AI engine generates the additional talking points based on the text context and the voice analysis.

18. The method of claim 17 further comprising:
selecting a moderator for the live session;
alerting the moderator when the deviation is detected, before deploying the corrective action; and
receiving instructions in real-time from the moderator, whether to deploy the corrective action upon receipt of the alert.

19. The method of claim 18 wherein the user associated with the user device on which the corrective action is deployed is prompted to accept or decline the corrective action.

20. The method of claim 19 wherein, upon the user declining the corrective action, the moderator is prompted to accept or decline blocking the user from further participation in the live session.
